(19) United States
(12) Patent Application Publication
(10) Pub. No.: US 2013/0015320 A1
(43) Pub. Date: Jan. 17, 2013

(54) METHOD AND APPARATUS FOR GENERATING FOCUS ERROR SIGNAL, OPTICAL HEAD AND OPTICAL DRIVING APPARATUS

(71) Applicants: Tomoto KAWAMURA, Yokohama (JP); Kotaro Oishi, Fujisawa (JP); Toshiteru Nakamura, Yokohama (JP)

(72) Inventors: Tomoto KAWAMURA, Yokohama (JP); Kotaro Oishi, Fujisawa (JP); Toshiteru Nakamura, Yokohama (JP)

(21) Appl. No.: 13/546,075

(22) Filed: Jul. 11, 2012

(30) Foreign Application Priority Data
Jul. 15, 2011 (JP) 2011-156263

(51) Int. Cl. G02B 27/40; G02B 27/10

(52) U.S. Cl. 250/201.4; 359/618

(57) ABSTRACT

In a method and apparatus for generating a focus error signal, an optical head and an optical driving apparatus are configured such that a light beam is divided into at least two light beams, coma aberration of a predetermined direction is added to one of the divided light beams, and coma aberration of a direction different from the predetermined direction of the coma aberration is added to the other divided light beam to thereby generate the focus error signal.

### INCORPORATION BY REFERENCE

The present application claims priority from Japanese application JP2011-156263 filed on Jul. 15, 2011, the content of which is hereby incorporated by reference into this application.

### BACKGROUND OF THE INVENTION

The present invention relates to a method for generating a focus error signal for controlling defocus of light.

In the background art of this technical field there is proposed JP-A-5-73945. This publication describes “light from a semiconductor laser 1 is condensed through a collimator lens 2, beam splitter 3, and objective lens 4 on an optical disk 5 as a spot, the reflected light is transmitted through the objective lens 4, beam splitter 3, and condenser lens 6 so as to be a detection light flux R, and one part is shielded by a knife edge 7, and made incident on a divided light receiving element 8 for focus detection. The light reflected on a light shielding face 7a is made incident on the light receiving element 9 for reproduction and track error detection. An edge face 7a of the knife edge 7 is formed like a recessed curved face, so that the quantity of light to a light receiving element 9 can be increased, and the linearity of the S-character-shaped curve of a focus error signal can be improved.”

### SUMMARY OF INVENTION

In the optical disc, BD (Blue-ray Disc), DVD (digital Versatile Disc), CD (Compact Disc) or the like are standardized. An optical head for recording and reproducing such an optical disc emits a light beam from a light source, condenses the light beam on the optical disc by an objective lens and detects the light beam reflected on the optical disc by using a photo-detector to generate from the detected signal, a reproduction signal of the optical disc, a track error signal for controlling a shift of a light spot on the optical disc from a guide groove in the optical disc (referred to as a “track” hereafter), and a focus error signal for controlling a defocus of the light spot on the optical disc.

An optical driving apparatus controls the position of the objective lens by an actuator using these generated signals to thereby place the light spot on a predetermined position of the optical disc. Control based on track-error signal is referred to as “tracking”, and control based on a focus error is referred to as “focusing”.

To generate such a focus error signal a knife edge method or the like is employed as shown in JP-A-5-73945. The knife edge method is characterized in that the inclination of a tangent range of the focus error signal is abrupt and therefore, the range of detection is narrow, and has a large problem to be solved in that focusing tends to be disabled for disturbance. Furthermore, another problem is that light is shielded by the edge of knife, so that the quantity of light to a signal decreases.

In view of the above-mentioned related art, an object of the present invention is to provide a method for generating a focus error signal which is free from loss of light quantity of signal, and provides an inclination of a desired tangent range and a desired detection range, a focus error signal generating apparatus using the method, or an optical head and a means for implementing an optical driving apparatus.

The above-mentioned object can be achieved by configurations defined in the scope of claims by way of example.

In accordance with the present invention, a focus error signal of light beam can be generated. Further, by making use of the generated signal an inexpensive optical head and optical driving apparatus can be realized.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for explaining the principle of a focus error signal generating method in Embodiment 1 according to the present invention.

FIG. 2 is an outline view of a light beam modulating element in Embodiment 2 according to the present invention.

FIG. 3 is a schematic view for explaining a focus error signal generating apparatus in Embodiment 2.

FIG. 4 is a waveform diagram for explaining a focus error signal in Embodiment 2.

FIG. 5 is a schematic diagram for explaining a spot on a light receiving face upon defocus in Embodiment 2.

FIG. 6 is an outline view of a light beam modulating element in Embodiment 3 according to the present invention.

FIG. 7A is an outline view of a light beam modulating element in Embodiment 4 according to the present invention.

FIG. 7B is an outline view for explaining operation of the light beam modulating element in Embodiment 4.

FIG. 8 is an outline view of an optical head in Embodiment 5 according to the present invention.

FIG. 9 is an outline view of a light beam modulating element in Embodiment 5.

FIG. 10 is an outline view of a photo-detector in Embodiment 5.

FIG. 11 is an outline view of an optical driving apparatus in Embodiment 5.

FIG. 12 is an outline view of a photo-detector in Embodiment 6 according to the present invention.

FIG. 13 is an illustration showing a result of simulation of a focus error signal in Embodiment 6.

FIG. 14 is a waveform diagram for explaining a focus error signal according to the knife edge method in Embodiment 2.

FIG. 15 is a diagram for explaining a spot on the light receiving face upon defocus according to the knife edge method in Embodiment 2.

### DETAILED EXPLANATION OF THE INVENTION

In the following, although the embodiments of the present invention will be explained in detail with reference to the accompanying drawings, the present invention is not limited to the embodiments.

### Embodiment 1

Embodiment 1 of the present invention will be described with reference to the drawings. Here is described a focus error signal generating method. FIG. 1 shows an illustration for explaining the focus error signal generating method in Embodiment 1. In FIG. 1, a light beam 310 travelling from the left side of the drawing sheet is shown by separating it into the upper side and the lower side of the drawing sheet. Respective light beams on the upper side and the lower side are shown in FIG. 1(1) and FIG. 1(2), respectively.

At first, explanation will be made of light beam 310 shown at the upper side of the drawing sheet and travelling from the left side of the drawing sheet in FIG. 1(1). The light beam 310 travelling from the left side of the drawing sheet is condensed by a condenser lens 300 as it travels towards the right side of the drawing sheet. Then, the light beam 310 is provided with a phase 302 by a light beam modulating element 301. The phase 302 is a phase of a direction in which the more is the light beam modulating element 301 toward the upper side of the drawing sheet the more the phase leads. Here, the phase of a direction in which the phase leads is assumed to be a phase which corresponds to a convex lens. The light beam 310 to which phase 302 is applied is detected by two light receiving faces including a light receiving face e305 and another light receiving face f306 which a photo-detector 304 has separately on upper and lower sides of the drawing sheet. If the light beam modulating element 301 is not provided, the light beam 310 will be condensed on the photo-detector 304 at one point through condenser lens 300. With provision of light beam modulating element 301 the light beam 310 is spread on the photo-detector 304 upwardly and downwardly of the drawing sheet without being condensed at one point.

Focus error of light beam 310 may be considered to be the same phenomenon as movement of photo-detector 304 in the lateral direction of the drawing sheet. For example, it is found from FIG. 1(1) that if the photo-detector 304 approaches light beam modulating element 301, the quantity of light incident on light receiving face e305 increases. Reversely, it is found from FIG. 1(1) that if the photo-detector 304 leaves remotely from light beam modulating element 301, the quantity of light incident on light receiving face f306 increases. Accordingly, it is found that by determining a difference between signals obtained from the light receiving faces e305 and B06, a signal having a predetermined inclination, that is, a focus error signal is generated depending upon a focus error or defocus of light beam 310.

Next, description will be made of a light beam on the lower side of the drawing sheet which travels from the left side of the drawing sheet with reference to FIG. 1(2). Light beam 310 travelling from the left side of the drawing sheet is condensed by the condenser lens 300 as the light beam 310 travels toward the right side of the drawing sheet. Subsequently, the light beam 310 is provided with a phase 303 by the light beam modulating element 301. The phase 303 is a phase having a direction in which the more is the light beam modulating element 301 toward the lower side of the drawing sheet, the more the phase lags. Here, the phase of a direction in which the phase lags is assumed to be a phase which corresponds to a concave lens. The light beam 310 to which phase 303 is applied is detected by two light receiving faces including a light receiving face g307 and another light receiving face h308 which a photo-detector 304 has separately on upper and lower sides of the drawing sheet.

It is found from FIG. 1(2) that if the photo-detector 304 approaches light beam modulating element 301, the quantity of light incident on light receiving face g307 increases. Reversely, it is found from FIG. 1(2) that if the photo-detector 304 leaves remotely from light beam modulating element 301, the quantity of light incident on light receiving face h308 increases. Accordingly, it is found that by determining a difference between signals obtained from the light receiving faces g307 and h308, a signal having a predetermined inclination, that is, a focus error signal is generated depending upon a focus error or defocus of light beam 310.

From the foregoing the focus error signal (FE) may perform an operation indicated in the following Expression (1). In the Expression, “e”, “f”, “g” and “h” indicate signals obtained from the light receiving faces e, f, g and h, respectively.

FE=(e+g)−(f+h) (1)

When the focus error signal is detected by only the light beam 310 in the upper half of the drawing sheet, if the photo-detector 304 and the light beam modulating element 301 cause an error in a vertical position thereof, there occurs a problem that the focus error signal offsets from a given error value. Therefore, it is desirable to use two light beams shown in the upper half and the lower half of the drawing sheet of FIG. 1. This will eliminate the offset of focus error signal because even though the photo-detector 304 and the light beam modulating element 301 raise an error in the vertical position thereof, the quantity of offset of focus error signal is equal between the upper half and the lower half.

As described above, one of light beams divided on the upper side and on the lower side is modulated to have a lead phase while the other is modulated to have a lag phase. However, such phase modulation to the light beam is generally called “coma aberration”. That is, the focus error signal generating method generates a focus error signal by applying coma aberration having a predetermined direction (phase leading direction) to one of at least two divided light beams and applying coma aberration having a direction different from said predetermined direction (phase lagging direction) to the other light beam. In FIG. 1, the light beam modulating element 301 applies the phase 302 in which a phase leads, to the light beam on the upper side, and applies the phase 303 in which a phase having a different direction than for the phase 302 leads, to the light beam on the lower side. Of course, the directions of the phases may be reversed to each other between the upper side and lower side.

### Embodiment 2

Embodiment 2 of the present invention will be described with reference to the accompanying drawings. Here is described a focus error signal generating apparatus using the focus error signal generating method disclosed in Embodiment 1.

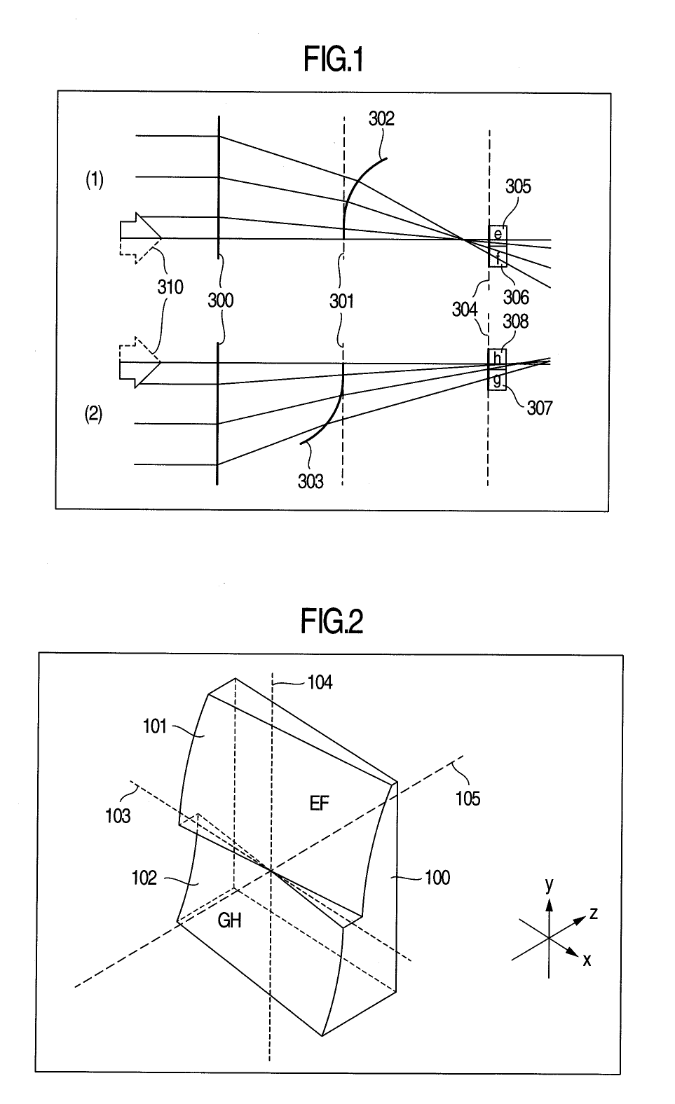

FIG. 2 shows a light beam modulating element 100 in Embodiment 2. In the Figure, x indicates the direction of an abscissa 103, y indicates the direction of an ordinate 104 and z indicates a direction 105 along which a light beam travels. The light beam modulating element 100 is assumed as a transparent material such as a glass, plastic or the like which has a property of permeating light beam. It is preferable to use a transparent plastic which is easy to mold. The light beam modulating element 100 has areas EF101 and GH102 divided in the y-direction. The area EF101 has a non-spherical shape (corresponding to a convex face) which decreases in thickness in accordance with the direction away from the area GH102 along the axis 104, and is configured to apply predetermined coma aberration to the light beam in a phase lead direction. The area EF101 is further made rotated in the direction of axis 104, and has a function of bending the travelling direction of the light beam together.

The area GH102 has a non-spherical shape (corresponding to a concave face) which increases in thickness in accordance with the direction away from the area EF101 along the axis 104, and is configured to apply predetermined coma aberration to the light beam in a phase lag direction which is opposite to the direction of area EF101. The area GH102 is further made rotated in the direction of axis 104 which is opposite to the area EF101, and has a function of bending the travelling direction of the light beam in a direction opposite to area EF101 together.

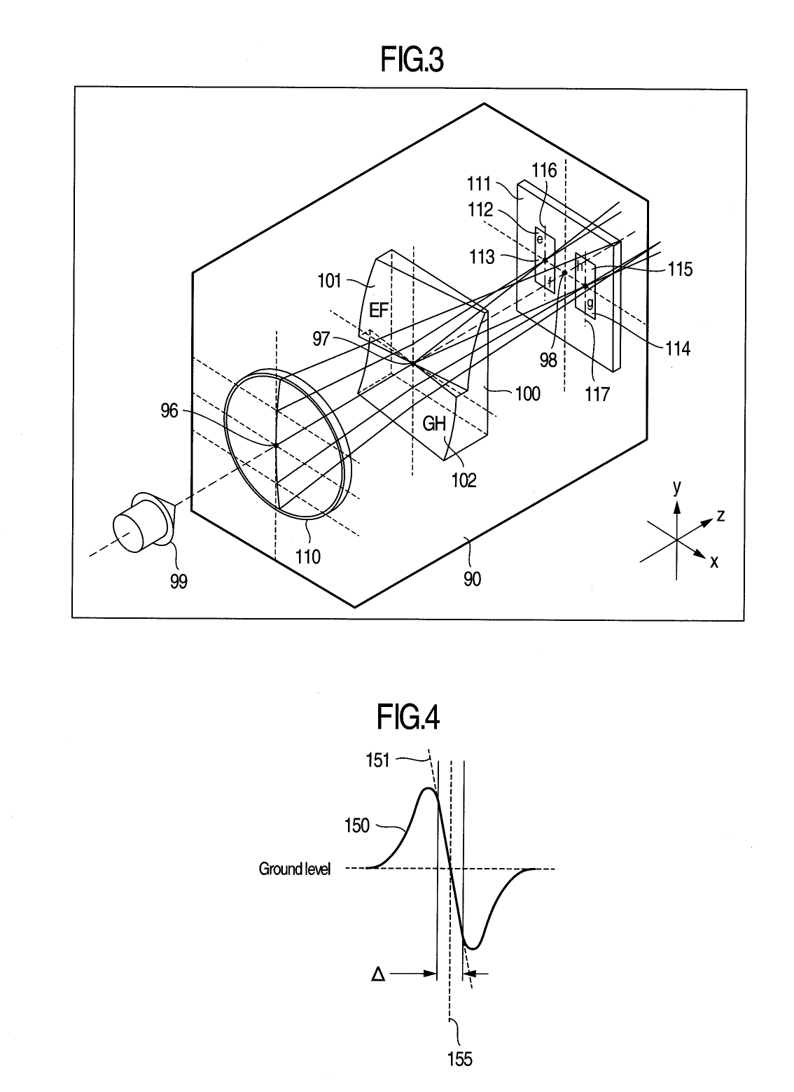

With reference to FIG. 3, description will be made of a focus error signal generating apparatus 90 employing the above-mentioned light beam modulating element 100. The focus error signal generating apparatus 90 comprises a condensing lens 110, the light beam modulating element 100 and a photo-detector 111.

A light beam 99 entered to the focus error signal generating apparatus 90 is condensed toward the photo-detector 111 (in the z-direction in the FIG. 3) by the condensing lens 110. Subsequently, the light beam 99 is entered to the light beam modulating element 100 disposed between the condensing lens 110 and the photo-detector 111. The light beam 99 is divided into two beams including a light beam passing through the area EF101 and another light beam passing through the area GH102, by the light beam modulating element 100. As described previously, coma aberrations of predetermined directions are added to the light beams passing through the areas EF101 and GH102, so that the light beams travel in predetermined directions. The two divided light beams 99 form light spots 116 and 117 at the photo-detector 111, and are detected by light receiving faces e112, f113, g114 and h115 disposed on the photo-detector 111. The boundary between the light receiving faces e112 and f113 and the boundary between the light receiving faces g114 and h115 may be set in the y-direction so as to generate a desired focus error signal.

In the focus error signal generating apparatus 90, it is desired to adjust center points 96, 97 and 98 of the condensing lens 110, the light beam modulating element 100 and the photo-detector 111 so as to just align to each other. The respective center points 96, 97 and 98 mean points which have been made as a reference in designing.

It is desired to adjust the photo-detector 11 so that the light spots 116 and 117 may be made substantially same in size, in the z-direction which is the travelling direction of light beam 99. This is to make a match between the zero point of focus error signal and the focus position. As previously described in Embodiment 1, the focus error signal is obtained by signal-processing a signal from the photo-detector according to the Expression (1).

FIG. 4 shows a focus error signal 150 obtained from the focus error signal generating apparatus 90 mentioned above. The focus error signal 150 becomes zero upon just focus, and large or small in quantity upon defocus, as shown in FIG. 4. A substantially-linear region of focus error signal 150 upon defocus (the range equal to a broken line 151) is called “a detection range Δ” which indicates a detectable range of quantity of defocus.

The required quantity of detection range Δ is different depending upon a different system. When the detection range Δ is required to be large, implementation can be made by making large the coma aberration applied by light beam modulating element 100. Making the quantity of coma aberration large corresponds to making the non-spherical shape of the areas 101 and 102 more in magnitude of the curvature.

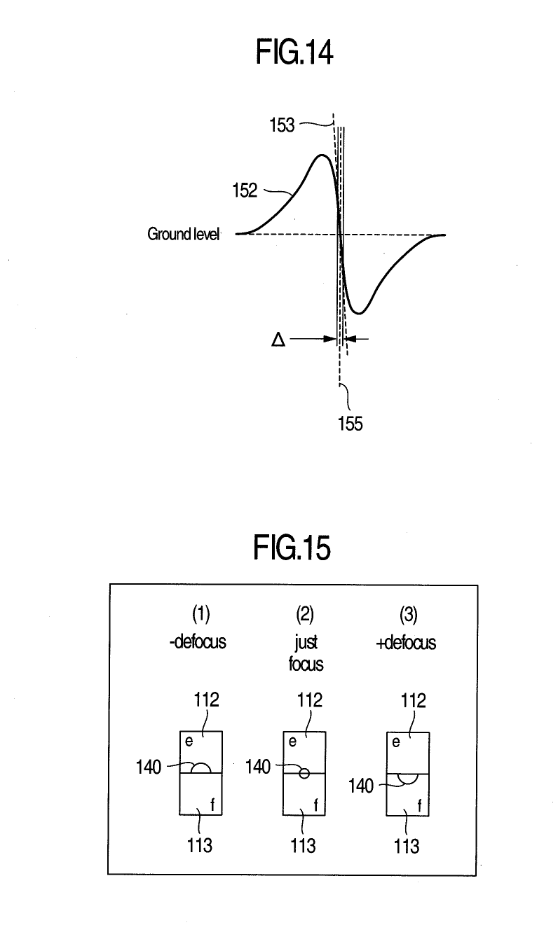

FIG. 14 shows a focus error signal 152 obtained using the knife edge method which has usually been well known. In the knife edge method, the detection range Δ of the focus error signal 152 which is a substantially linear region (the range matched with a broken line 153) is considerably narrow as compared with that of the focus error signal 150.

FIG. 5 illustrates defocus characteristics of a light spot 116 which is formed on the light receiving faces e112 and f113 of focus error signal generating apparatus 90. FIG. 5(1) shows the case where the defocus is negative, FIG. 5(2) shows the case of just focus and FIG. 5(3) shows the case where the defocus is positive.

As shown in FIG. 5(1), when the defocus is negative, the light spot 116 is of a shape which elongates on the side of light receiving face e112.

As shown in FIG. 5(2), at just focus the light spot 116 is of a slender shape extending on both sides of light receiving faces e112 and f113. As shown in FIG. 5(3), when the defocus is positive, light spot 116 extends in long shape on the side of light receiving face f113. That is, even when the just focus is changed to the defocus by the added coma aberration, the light spot 116 is kept to exist on both of light receiving faces e112 and f113.

FIG. 15 shows defocus characteristics of light spot 140 formed on the light receiving faces e112 and f113 when use of the knife edge method is assumed like FIG. 14, as compared with FIG. 5.

As shown in FIG. 15(1), when the defocus is negative, the light spot 140 is a half circle in shape on the side of light receiving face e112. As shown in FIG. 15(2), at just focus the light spot 140 is of shape of a small circle over both sides of the light receiving faces e112 and f113. As shown in FIG. 15(3), when the defocus is positive, the light spot 140 is a half circle in shape on the side of light receiving face f113. That is, even when the just focus is slightly changed to the defocus, the whole light beam will enter to either of light receiving faces e112 and f113. Therefore, the detection range of focus error signal 152 which is obtained by the knife edge method is made to be narrow.

In the knife edge method, it is usual to make the boundary between light receiving faces e112 and f113 with a wide dark line in order to avoid such a narrow detection range. However, the dark line has a characteristic that the response to photo-electric conversion is low. Accordingly, it is appreciated that a focus error signal provided from focus error signal generating apparatus 90 according to the present embodiment without using the dark line is high in response and has a good frequency characteristic.

### Embodiment 3

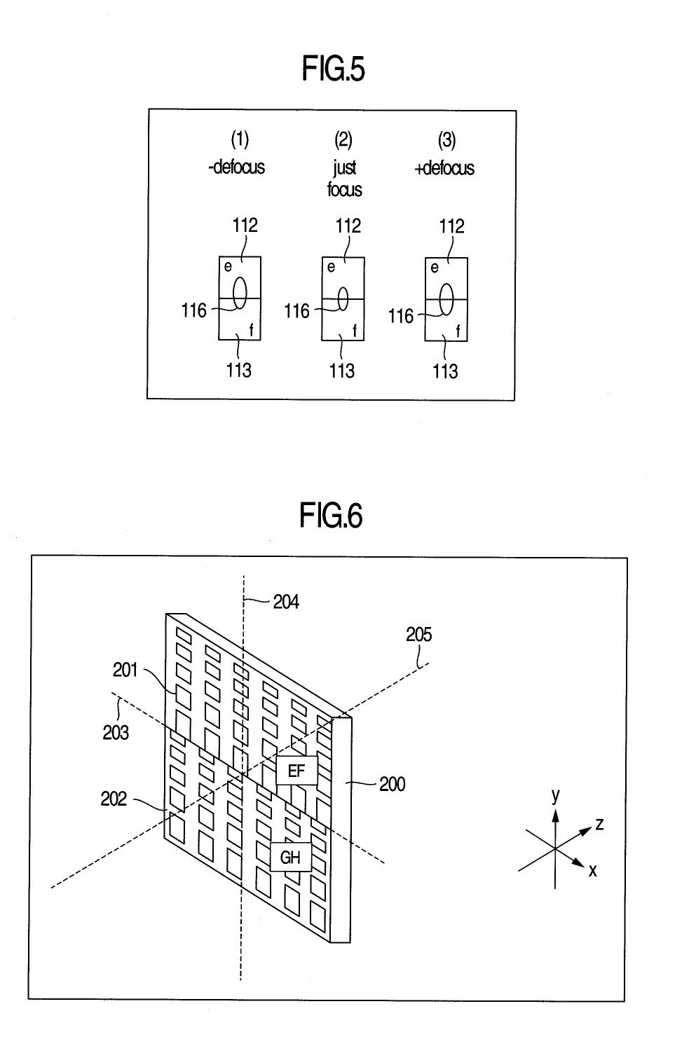

Description will be made of Embodiment 3 according to the present invention with reference to FIG. 6. A modification of light beam modulating element 100 described in Embodiment 2 is described here.

FIG. 6 shows a light beam modulating element 200 according to Embodiment 3. In FIG. 6, x indicates the direction of a horizontal axis 203, y indicates the direction of a vertical or height axis 204, and z shows a travelling direction 205 of light beam. The light beam modulating element 200 is different from light beam modulating element 100, is formed of a diffraction grating, and includes areas EF201 and GH202 divided in the y-direction. The area EF201 is a diffraction grating which includes in combination, equi-spaced diffraction gratings parallel with the vertical axis 204, and in equi-spaced diffraction gratings having spaces (lengths along axis 204) which are narrower as are away from the area GH202 along axis 204. As mentioned previously, the equi-spaced diffraction gratings are deployed to function to bend the travelling direction of the light beam. The in equi-spaced diffraction gratings are deployed to function to apply coma aberration. Therefore, the area EF201 has the same function as area EF101 of the light beam modulating element 100.

The area GH202 is a diffraction grating which includes in combination, equi-spaced diffraction gratings parallel with axis 204, and in equi-spaced diffraction gratings having spaces (lengths along axis 204) which are wider as are away from the area EF201 along axis 204. The equi-spaced diffraction gratings are deployed to function to bend the travelling direction of the light beam. The in equi-spaced diffraction gratings are deployed to function to apply coma aberration. The area GH202 has the same function as area GH102 of the light beam modulating element 100.

As described above, in order to provide the necessary function the light beam modulating element may be implemented by a surface shape as in the light beam modulating element 100 or by using diffraction gratings as in the light beam modulating element 200. For example, utilization of the surface shape provides advantages that the change due to the wavelength of light beam is small and the transparency is high compared with utilization of diffraction grating. Reversely, utilization of diffraction grating provides advantages that precision of fine shaping is high and light beam can be split into diffraction light beams of ±1st order or the like for each area. Therefore, necessary measures may be selected according to the system.

### Embodiment 4

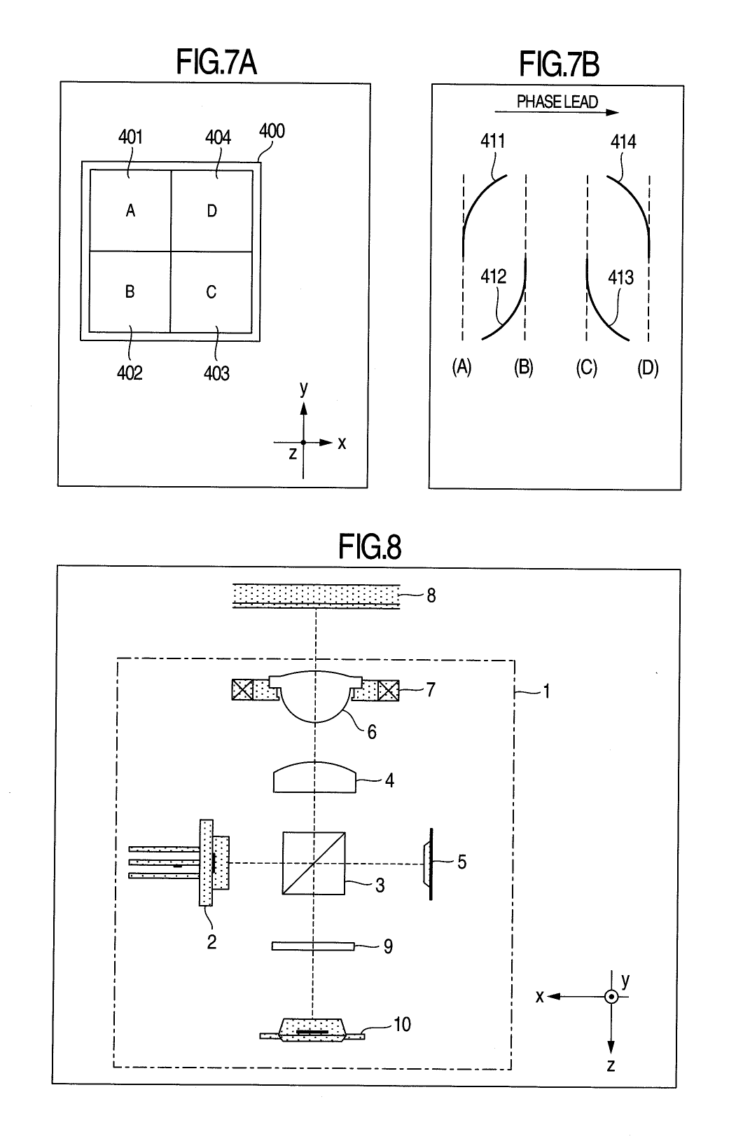

Description will be made of Embodiment 4 of the present invention with reference to FIGS. 7A and 7B. A modification of a light beam modulating element 100 explained in Embodiment 2 is described.

FIG. 7A shows a light beam modulating element 400 according to Embodiment 4. In FIG. 7A, x indicates a lateral direction, y indicates a vertical (height) direction, and z indicates a travelling direction 205 of light beam. The light beam modulating element 400 includes four (4) areas, which is different from the light beam modulating element 100. The light beam modulating element 400 is divided into four divisions in the lateral direction and in the vertical direction as shown in FIG. 7A, and an area A401, area B402, area C403 and area D404 are deployed as the four divisions.

When a light beam is entered to the light beam modulating element 400, the light beam is divided into four beams to the respective areas. To the light beam incident on the area A401 applied is a lead phase 411 which leads in phase in the y-direction of the drawing sheet as shown by (A) of FIG. 7B. Illustrations (A) to (D) in FIG. 7B show phases 411 to 414 applied when the light beam modulating element 400 is viewed from the x-direction, respectively. To the light beam incident on the area B402 applied is a lag phase 412 which lags in phase in the y-direction of the drawing sheet as shown by (B) of FIG. 7B. To the light beam incident on the area C403 applied is a lead phase 413 which leads in phase in the y-direction of the drawing sheet as shown by (C) of FIG. 7B. To the light beam incident on the area D404 applied is a lag phase 414 which lags in phase in the y-direction of the drawing sheet as shown by (D) of FIG. 7B.

Assuming that the area EF101 and area GH102 of the light beam modulating element 100 are area A401 and area B402, respectively, the area C403 corresponds to an inversion of area EF101 with respect to the vertical direction, and the area D404 corresponds to an inversion of area GH102 with respect to the vertical direction. That is, according to the mechanism as described in Embodiment 1, there occurs no problem if a plurality of areas are included as in the light beam modulating element 400. The division of area may be selected in accordance with combination with other signals required for the system. When employing the light beam modulating element 400, the light receiving face of the photo-detector is required to be set so as to match with the light beam modulating element 400. Further, the travelling direction of the light beam may be set so as to match with the set light receiving face by making the light beam travelling direction different for each area.

### Embodiment 5

Embodiment 5 of the present invention will now be described with reference to the drawing Figures. An optical head and an optical driving apparatus are described by way of example. They correspond to an optical head and an optical driving apparatus which are capable of recording and/or reproducing an optical disc conforming to, for example, the DVD standard, BD (blue-ray disc) standard or the like.

FIG. 8 diagrammatically shows an outline configuration of an optical head 1. A light beam is emitted as a divergence light beam from a light source 2 in a direction parallel with x in FIG. 8. In order to record information on an optical disc or reproduce the information from the optical disc it is usual to use a semiconductor laser, and the light source 2 corresponds to the semiconductor laser emitting at a predetermined wavelength. The light beam emitted from the light source 2 enters a light beam splitter 3. The light beam splitter 3 permeates the entered light beam by a predetermined quantity of light, and reflects the remaining quantity of light, thus constituting an optical element for splitting a light beam into two beams. Such a function can be implemented by a half prism, polarized prism or the like. A reflection beam among the light beam entered to the light beam splitter 3 travels on a condenser lens 4, and the light beam passing through the light beam splitter 3 travels to a front monitor 5. The light beam travelling on the condenser lens 4 is converted to a substantially parallel light beam.

Generally, the quantity of light of a light beam emitted from a light source is proportional to an injected current, but problems to be solved are that the current to such light quantity has a large individual offset, and changes with the peripheral temperature. When an optical disc is reproduced, especially recorded, the light quantity of optical beam directed to the optical disc must be controlled exactly. Therefore, the optical head 1 detects by the front monitor 5 the light quantity of light beam which permeates the light beam splitter 3 and is split thereby, thus providing feedback control so that the quantity of light on the optical disc may be a predetermined value.

The light beam which is converted to be substantially in parallel by the condenser lens 4 enters to an objective lens 6 and is condensed on an information face of an optical disc 8. The objective lens 6 is mounted on an actuator 7 and can be driven at least in the x-direction and the z-direction in FIG. 8. In the Figure, x indicates a direction orthogonal to the information face of optical disc 8, that is, a radial direction of the optical disc 8, z indicates a direction normal to the information face of optical disc 8, and y indicates a direction parallel to the track on the information face (hereafter referred to as “track direction”). In other words, the x-direction is used for control by a track error signal and driving of objective lens shift, and the z-direction is used for control by a focus error signal.

A light beam reflected on the optical disc 8 enters to a light beam modulating element 9 through the objective lens 6, condenser lens 4 and light beam splitter 3. The light beam modulating element 9 has a function of dividing the light beam entered to the light beam modulating element 9 to respective predetermined areas for signal generation. The light beams divided by the light beam modulating element 9 are detected on a light receiving face of a photo-detector 10. The light beams introduced into the photo-detector 10 are used to generate a reproduction signal recorded on the information face of the optical disc 8 and generate a track error signal, a focus error signal or the like. The light beam modulating element 9 may be disposed on a light path common to, for example, an outward path and a return path (that is, between light beam splitter 3 and objective lens 6). This case is implemented by making use of polarization such that a light beam in the outward path is not divided and only light beam in the return path is divided. Since an optical element having polarization is expensive compared with optical components having no polarization, it is desired from the viewpoint of cost to dispose light beam modulating element 9 between light beam splitter 3 and photo-detector 10, as in the optical head 1.

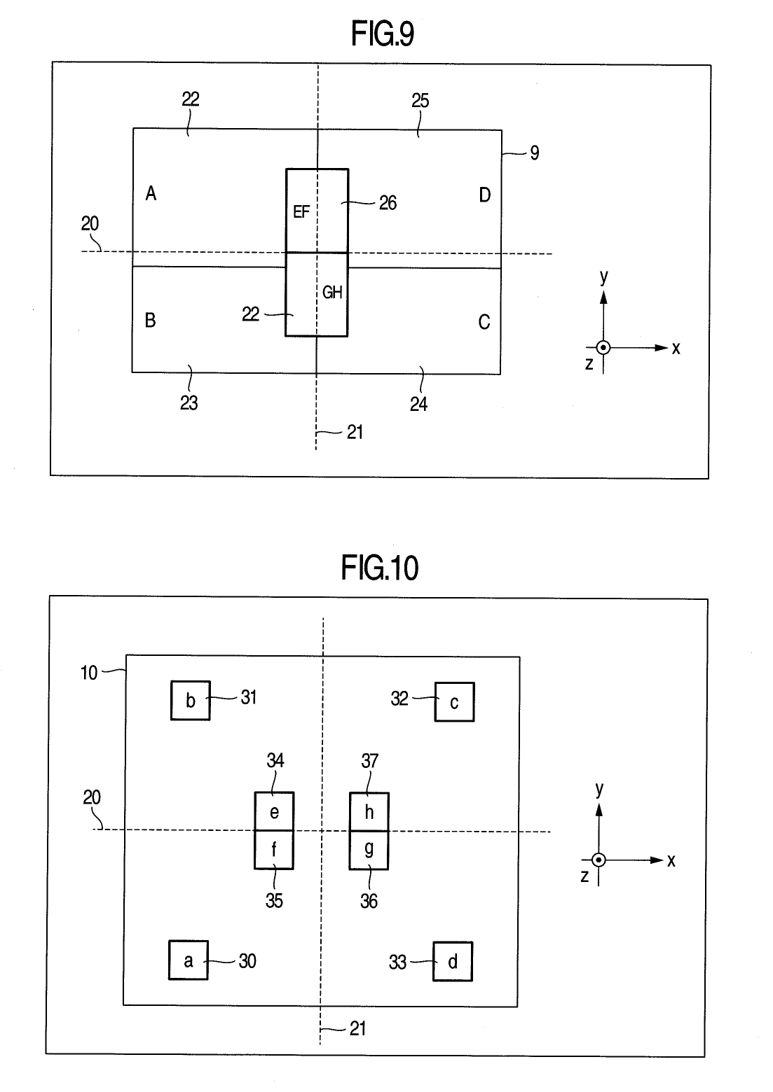

Next, the light beam modulating element 9 will be described. FIG. 9 shows an outline of configuration of the beam modulating element 9, which is viewed from the light beam splitter 3. In FIG. 9, z indicates a direction normal to light beam modulating element 9, x indicates a lateral direction and y indicates a vertical (height) direction. Especially, when assuming the section of an entered light beam, the radial direction of optical disc 8 is the x-direction, and a track direction on the optical disc 8 corresponds to the y-direction. That is, a broken line 20 corresponds to the radial direction of optical disc 8 and a broken line 21 corresponds to a track direction thereon. The intersection point between broken lines 20 and 21 is assumed to be a center which means a reference upon setting of the beam modulating element 9. That is, when assembling optical head 1, it is desired to adjust the light beam modulating element 9 in the x-direction and/or in the y-direction so that the intersection point between broken lines 20 and 21 may coincide with the center of light beam entered to light beam modulating element 9.

The light beam modulating element 9 serves to divide a light beam entered thereto into light beams for respective predetermined areas in order to generate a focus error signal and a track error signal. An example of light beam modulating element 9 based on an assumption that settings of face angle and face shape are different for every area of the modulating element 9 will be described.

The light beam modulating element 9 is constituted by six areas including areas A22, B23, C24, D25, EF26 and GH27. The areas A22, B23, C24 and D25 have functions of making entered light beams travel in predetermined directions. The functions can be realized by slanting the respective faces in predetermined directions. Area EF26 corresponds to the area EF101 of the light beam modulating element 100 and has functions of making the entered light beam in a predetermined angle direction and applying coma aberration thereto. Area GH27 corresponds to the area GH102 of the light beam modulating element 100 and has functions of making the entered light beam in a predetermined angle direction and applying coma aberration thereto. Areas A22 and B23 and areas C24 and D25 are divided by a broken line 21 in lateral direction (leftward and rightward). Areas A22 and B23 are divided by a line parallel with a broken line 20 in upward and downward directions. The boundary between areas A22 and B23 is made to offset on a lower side in FIG. 9 by a predetermined amount than the broken line 20. Areas C24 and D25 are divided by a line parallel with the broken line 20 in upward and downward directions. The boundary between areas C24 and D25 is made to offset on a lower side in FIG. 9 by a predetermined amount than the broken line 20. At this time, it is desired to set the offset amount of the boundary between areas A22 and B23 from the broken line 20 and the offset amount of the boundary between areas C24 and D25 from the broken line 20 so that both amounts may be substantially same. The offset amounts which are too large or too small are not desirable from the viewpoint of system in optical driving apparatus because of a large correction coefficient described later. It is desirable that the offset amount is set by as large as 5 to 35 percent of the effective diameter of light beam entered to the light beam modulating element 9.

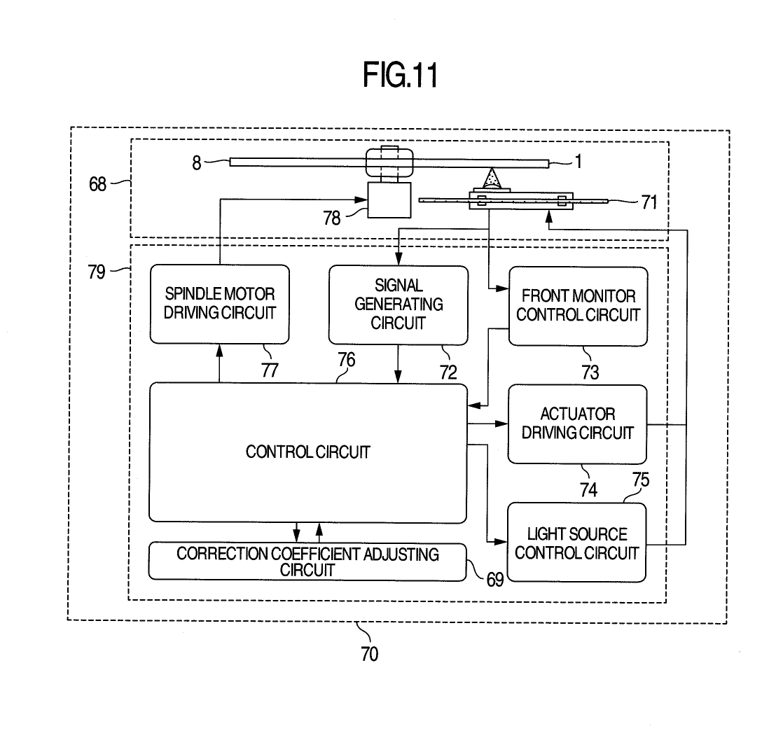

Next, the photo-detector 10 will be described. FIG. 10 shows an outline of configuration of the photo-detector 10. FIG. 10 is a figure where the photo-detector 10 is viewed from the beam splitter 3. The photo-detector 10 is constituted by eight (8) light receiving faces including light receiving faces a30, b31, c32, d33, e34, f35, g36 and h37. A light beam divided by area A22 of the light beam modulating element 9 is here expressed as “light beam A”, for example. In the following, the other areas will be expressed as the like. The light receiving face a30 receives the light beam A. The light receiving face b31 receives a light beam B. The light receiving face c32 receives a light beam C. The light receiving face d33 receives a light beam D. The light receiving faces e34 and f35 receive a light beam EF. The light receiving faces g36 and h37 receive a light beam GH. For example, when a multi-layered optical disc is reproduced, there is a problem to be solved that a light beam reflected from an information surface different from an information surface currently reproduced in the multilayered optical disc is a disturbance as stray light from another layer. In order to avoid such stray light from another layer it is desirable to arrange the light receiving face so as to prevent the multilayer stray light from entering. To this end, the light receiving face a30 receiving the light beam A is arranged in the left lower position among FIG. 10 so that the stray light may shift toward the left upper position and the right lower position of the drawing sheet. In the like manner another light receiving face is set to prevent stray light from the other layer from entering.

Description will be made of operation for generating a signal required for an optical driving apparatus based on a signal provided by the photo-detector 10. A focus error (FE) signal is generated based on the above-mentioned Expression (1). A push-pull (PP) signal, an objective lens shift error (LE) signal, a track error (TE) signal and a reproduction (RF) signal are generated based on the following Expressions (2), (3), (4) and (5), respectively.

PP=(a+b)−(c+d) (2)

LE=(kl×b+c)−(a+kl×d) (3)

RE=PP−k2×LE (4)

RF=(a+b+c+d+e+f+g+h) (5)

In the above-described Expression (5) a numeral “a” corresponds to a signal detected from the light receiving face a30. In the same manner, numerals “a”-“b” correspond to signals detected from light receiving faces b31 to h37, respectively. In the following, the numeral “a” will be referred to as “signal a”. The above-described k1 and k2 indicate correction coefficients. The correction coefficient kl may be set so that a push-pull amplitude of the signal a or the signal b may be offset with that of the signal d or the signal b. The correction coefficient k2 may be set so that offsets of PP signal and LE signal when the objective lens is shifted may be cancelled out to each other.

Here, the reproduction signal from the optical disc is a high-frequency signal. In said knife edge method, when a wide dark line is used, the frequency characteristics are deteriorated, so that such dark line can not be used as a reproduction signal. When no dark line is used by applying a phase to a light beam as in this embodiment, it is advantageous that a signal on the light receiving face which generates a focus error signal can be used as the reproduction signal. In addition, since a knife edge is not deployed and the wide dark line is not used, there is an advantage that the utility efficiency of light beam to signal is high.

Description will be made of an optical driving apparatus 70 on which the optical head 1 is mounted. FIG. 11 shows in block diagram an outline of configuration of optical driving apparatus 70. The optical driving apparatus 70 comprises a device block 68 and a circuit block 79. At first, the device block 68 will be described, in which optical disc 8 is fixed to a spindle 78, and the spindle 78 has a function of making the optical disc 8 rotate. The optical driving apparatus 70 includes a guide cover 71 therein along which the optical head 1 is accessible to a predetermined radial position of the optical disc 8.

The circuit block 79 will be described next. When an information processing unit such as a personal computer issues an instruction indicative of reproduction of information on the optical disc 8 to the optical driving apparatus 70, the instruction is transmitted to a control circuit 76 in the optical driving apparatus 70. In response to reception of the instruction the control circuit 76 controls a spindle driving circuit 77 to drive the spindle 78 and thereby start rotation of the optical disc 8. Then, the control circuit 76 controls a light source control circuit 75 to lit the light beam from the light source 2 at a light quantity needed for reproduction. Then the control circuit 76 controls an actuator driving circuit 74 to drive the actuator 7 (in FIG. 8) in the normal direction of the optical disc 8. A signal detected from the photo-detector 10 of the optical head 1 is sent to a signal generating circuit 72, in which a focus error signal is generated according to the Expression (1). The control circuit 76 controls the actuator driving circuit 74 by using the focus error signal to perform focusing on a predetermined information face of the optical disc 8.

After the focusing the control circuit 76 controls the signal generating circuit 72 to generate a PP signal, LE signal and TE signal according to the Expressions (2), (3) and (4). At first, the control circuit 76 controls the actuator driving circuit 74 so that the offset of PP signal may be zero, whereby the actuator 7 is moved in the radial direction of the optical disc 8. This corresponds to shift of the objective lens.

In a usual optical head, it is not possible due to the error caused in assembly that the center of optical beam is made to fully match with the intersecting point of broken lines 20 and 21 of the light beam modulating element 9. Therefore, by shifting the objective lens so as to make the offset of PP signal zero, the error in the x-direction in FIG. 9 among the assembly error can be corrected.

The control circuit 76 controls a correction coefficient adjusting circuit 69 so as to make an AC component which is the push-pull (PP) signal of LE signal, at minimum, to thereby adjust the correction coefficient k1. Next, the control circuit 76 controls the actuator driving circuit 74 to periodically operate the actuator 7 in the radial direction of the optical disc 8. At this time, the control circuit 76 monitors offsets of the PP signal and the LE signal and controls the correction coefficient adjusting circuit 69 so as to make the offsets of these signals substantially same to thereby adjust the correction coefficient k2.

By performing the processing described above the optical driving apparatus 70 can absorb the assembly error of the light beam modulating 9, thus providing good FE and TE signals.

Next, the control circuit 76 controls the actuator driving circuit 74 to stop the periodical operation of actuator 7, and perform tracking into a predetermined track on the optical disc 8 using the obtained TE signal. After the tracking, the control circuit 76 causes the signal generating circuit 72 to generate an RF signal according to the Expression (5). It is desirable to adjust focusing and tilt of objective lens 6 so as to cause the generated RF signal to have the best reproduction performance (for example, jitter or signal amplitude). The control circuit 76 sends the obtained RF signal to an information home-use appliance such as a personal computer to complete the instruction of reproduction.

As described above, the circuit block 79 of the optical driving apparatus 70 controls the device block 68 to thereby obtain desired reproduction information. Further, the control circuit 76 has a function of moving the optical head 1 to a predetermined radial position along a guide bar 71 according to the necessity. The control circuit 76 also has a function of always monitoring a signal obtained from the front monitor 5 by a front monitor control circuit 73 and controlling a light source control circuit 75 so that the light quantity of a light beam emitted from the light source 2 may be a predetermined value. The control circuit 76 has another function of upon reception of an instruction for recording information on the optical disc, driving the light source control circuit 75 after tracking similarly to the reproduction mentioned above, and controlling the light quantity of light beam emitted from the light source 2 to thereby record information on the optical disc. Although the embodiment of the optical driving apparatus 70 is described above, the invention is not limited to the above embodiment if the signal generating circuit 72 is mounted therein. In the foregoing, according to the present invention, even though an objective lens shift from the optical disc occurs, an optical head and an optical driving apparatus capable of generating TE signal free from the offset can be provided.

As described with respect to the present embodiment, in generating the focus error signal it is not necessary to provide a wide dark line at the boundary between the light receiving faces e34 and f35 of the photo-detector 10. In the like manner, it is not necessary to provide a wide dark line also at the boundary between the light receiving faces g36 and h37. That is, signals obtained from the light receiving faces e34, f35, g36 and h37 have good frequency characteristics, so making it possible to generate a RF signal using the Expression (5). Conventionally, the knife edge method requiring a wide dark line has a problem with respect to signal-to-noise (SN) ratio in that a light beam for generating a FE signal and a light beam for generating a RF signal are required, so that a diffraction grating must perform splitting into diffraction light beams of ±1st order, so lowering the efficiency of light beam used in RE In contrast, the focus error signal generating method described with respect to the present embodiment makes it possible to commonize the light receiving faces for FE and RF for the light beam. In other words, in the present embodiment, no light beam is needed to split using diffraction grating or the like, thus greatly improving the efficiency of light beam for use in RE In the foregoing, the optical head 1 and the optical driving apparatus 70 according to the Embodiment 5 are applications of the focus error signal generating apparatus 90 including condenser lens 4, light beam modulating element 9 and photo-detector 10.

### Embodiment 6

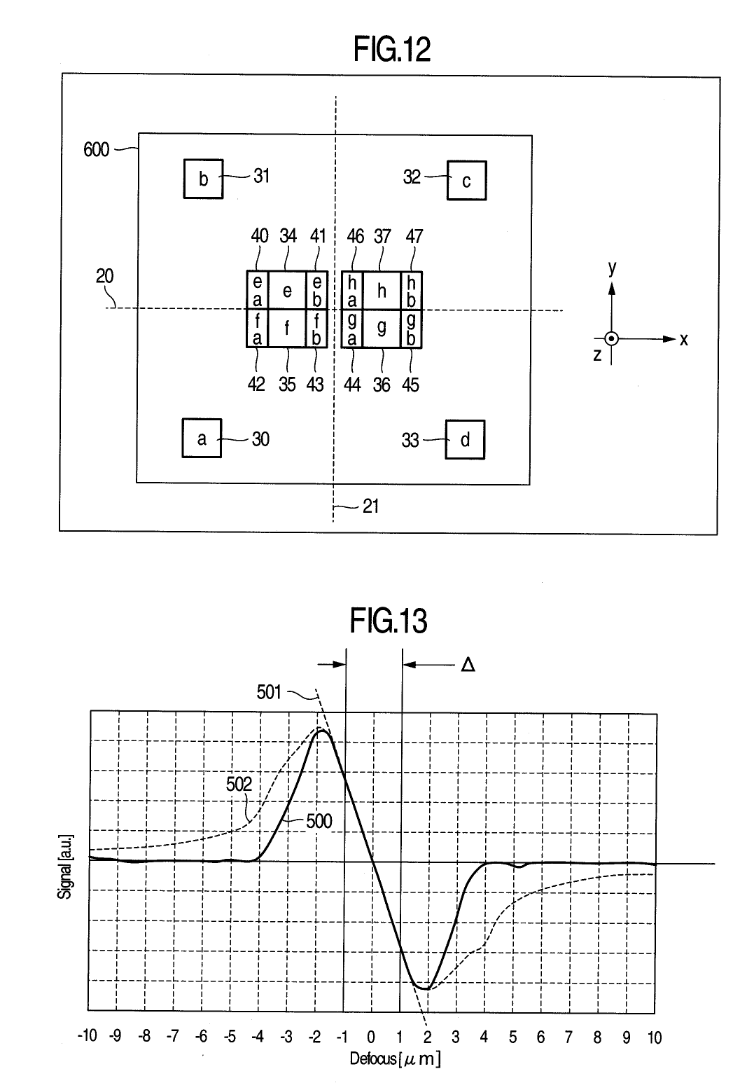

Embodiment 6 of the present invention will be described with reference to FIG. 12, where a photo-detector 600 which is a modification of the photo-detector 10 of the Embodiment 5 will be described. The photo-detector 600 is configured to include additional light receiving faces to the photo-detector 10. In the photo-detector 600, eight additional light receiving faces ea40, eb41, fa42, fb43, ga44, gb45, ha46 and hb47 are added to the photo-detector 10. The total area of light receiving faces ea40 and eb41 is set to be same in size as the area of light receiving face e34. The total area of light receiving faces fa42 and fb43 is set same in size as the area of light receiving face 135. The total area of light receiving faces ga44 and gb45 is set same in size as the area of light receiving face g36. The total area of light receiving faces ha46 and hb47 is set same in size as the area of light receiving face h37.

Description will be made of operation of generating a signal necessary for an optical driving apparatus based on a signal from the photo-detector 600. A focus error (FE) signal is obtained from the following Expression (6). The other push-pull (PP) signal, objective lens shift error (LE) signal and track error (FE) signal and reproduction (RF) signal are same as those obtained with respect to the photo-detector 10.

FE=(e+g+fa+fb+ha+hb)−(f+h+ea+eb+ga+gb) (6)

In the Expression (6), ‘ea’ corresponds to a signal detected on the light receiving face ea40. The above-mentioned relation is similar to the other signals, as well.

Next, description will be made of a simulation result of FE signal when assuming an optical head for reproducing, for example, a BD (blu-ray disc). Simulation conditions in one example are at first described in the following. Areas EF26 and GH27 of light beam modulating element 9 were set to be 25% to 32% in size for x-axis to y-axis relative to the effective aperture of incident light beam. When the quantity of coma aberration φ is expressed by a y-axis function indicated in the following Expression (7), it was set that C1/C2=−1.6 λ/+1.6 λ for area EF26, and C1/C2=+1.6 λ/−1.6 λ for area GH27.

φ=C1·y\hat{0}4+C2·y\hat{0}×6 (7)

where the boundary between area EF26 and area GH27 is set to be zero for the y-axis. In the coma aberration φ the direction of phase lead in z-direction is defined to be positive. The wavelength λ=405 nm. Each of the light receiving faces e34, f35, g36 and h37 of photo-detector 600 was set to be 20 μm wide and 40 μm high. Each of the light receiving faces ga44, gb45, ha46 and hb47 of photo-detector 600 was set to be 10 μm wide and 40 μm high.

FIG. 13 shows a result of simulation for a focus error signal, where the abscissa indicates a defocus quantity and the ordinate indicates a signal level of a focus error signal. FIG. 13 shows the results that a focus error signal 500 is simulated by the photo-detector 600 and a focus error signal 502 is simulated by the photo-detector 10. The detection range exhibiting a linearity (the range equal to a broken line 501) is as small as 2 μm in both cases. This detection range is assumed and set as a detection range of BD which is of no problem.

The focus error signal 502 does not become zero even when the defocus is beyond ±6 μm. It is called a wide hem focus error signal that when thus defocused the focus error signal does not converge to zero. In contrast, it may be called a well-defined focus error signal that the focus error signal 500 becomes substantially zero where the defocus is beyond ±4 μm.

In multi-layered discs of BD and DVD, it is desirable that a focus error signal is well defined. To this end, as has been described on the photo-detector 600, it is possible to improve sharp hem of focus error signal according to necessity by using an additional light receiving face. When defocused the spot of photo-detector becomes larger. In the case of photo-detector 10, when defocused, the shape of light spot in the vertical direction (in the y-direction) becomes non-symmetrical due to influence of coma aberration, resulting in a wide hem FE signal. Even the vertically (in the y-direction) non-symmetrical light spot is symmetrical horizontally (in the x-direction), so that in order to improve the sharp definition of FE signal utilizing the symmetry the photo-detector 600 is provided with additional light receiving faces ea40 and eb41, fa42 and fb43, ga44 and gb45, ha46 and hb47 on both sides of light receiving faces e, f, g and h, respectively.

As described above, the focus error signal generating method comprises dividing a light beam into at least two beams, applying coma aberration of a predetermined direction to one of the divided light beams, and applying coma aberration of a different direction than that of the one divided light beam to the other divided light beam to thereby generate a focus error signal of light beam.

In the focus error signal generating method, a dividing line for dividing a light beam into two beams (for example, the boundary between areas EF101 and GH102 of light beam modulating element 100) is made to be substantially orthogonal to a direction in which coma aberration is added (for example, a y-direction in which there exists a non-spherical shape of areas EF101 and GH102 of light beam modulating element 100).

The focus error signal generating apparatus comprises a condenser lens for condensing a light beam, a light beam modulating element for dividing the light beam condensed by the condenser lens into at least two light beams, applying coma aberration of a predetermined direction to one of the divided light beams and applying coma aberration of a direction different from the coma aberration of the predetermined direction, to the other divided light beam, and a photo-detector for detecting the quantities of light of the two divided light beams as signals to generate a focus error signal of light beam bases on the signals detected by the photo-detector.

The photo-detector of the focus error signal generating apparatus comprises at least two light receiving faces (for example, light receiving faces e112 and f113 of photo-detector 111) which receive one of two divided light beams, and at least two light receiving faces (for example, light receiving faces g114 and h115 of photo-detector 111) which receive the other divided light beam, to thereby generate a focus error signal of light beam from signals of the photo-detector obtained from at least the four light receiving faces.

In the focus error signal generating apparatus, a dividing line in dividing a light beam into two light beams (for example, the boundary between areas EF101 and GH102 of light beam modulating element 100) is substantially orthogonal to the boundary between at least two light receiving faces which receive one of the divided light beams (for example, the boundary between light receiving faces e112 and f113 of photo-detector 111).

The optical head comprises a light source for emitting a light beam, a condenser lens for condensing the light beam, a light beam modulating element for dividing the light beam condensed by the condenser lens into at least two light beams, applying coma aberration of a predetermined direction to one of the split light beams and applying coma aberration of a direction different from the predetermined direction to the other divided light beam (for example, means including areas EF26 and GH27 of light beam modulating element 9), and a photo-detector for detecting the quantities of light of the two divided light beams as signals to thereby detect the signals necessary for generating a focus error signal of light beam, from the photo-detector.

In the optical head, a dividing line in dividing a light beam into two beams is made to be substantially orthogonal to a direction in which coma aberration is added.

The photo-detector of the optical head comprises at least two light receiving faces which receive one of two divided light beams (for example, light receiving faces e34 and f35 of photo-detector 10) and at least two light receiving faces which receive the other divided light beam (for example, light receiving faces g36 and h37 of photo-detector 10) to thereby detect signals required for generating a focus error signal, from at least the four light receiving faces.

In the optical head, a dividing line for dividing a light beam (for example, the boundary between areas EF26 and GH27 of light beam modulating element 10) is made to be substantially parallel with the boundary between at least two light receiving faces which receive one divided light beam (for example, the boundary between light receiving faces e34 and f35 of photo-detector 10).

The optical driving apparatus comprises a signal generating circuit which generates a focus error signal from a signal provided by the optical head.

It should be further understood by those skilled in the art that although the foregoing description has been made on embodiments of the invention, the invention is not limited thereto and various changes and modifications may be made without departing from the spirit of the invention and the scope of the appended claims.

1. A focus error signal generating method comprising:
a step of dividing a light beam into at least two light beams;
a step of applying coma aberration of a predetermined direction to one of the divided light beams; and
a step of applying coma aberration of a direction different from the predetermined direction to the other divided light beam to thereby generate a focus error signal of the light beam.

2. A focus error signal generating method according to claim 1, wherein
the direction of a dividing line in dividing the light beam into at least two light beams is made to be substantially orthogonal to the directions in which the coma aberrations are added.

3. A focus error signal generating apparatus comprising:
a condenser lens which condenses a light beam;
a light beam modulating element which divides the light beam condensed by the condenser lens into at least two light beams, applies coma aberration of a predetermined direction to one of the divided light beams, and applies coma aberration of a direction different from the predetermined direction of the coma aberration, to the other divided light beam; and
a photo-detector which detects quantities of light of the two divided light beams as signals,
thereby generating a focus error signal of the light beam from the signals detected by the photo-detector.

4. A focus error signal generating apparatus to claim 3, wherein
the photo-detector comprises at least two light receiving faces which receive the one divided light beam and at least two light receiving faces which receive the other divided light beam,
thereby generating the focus error signal of the light beam based on signals of the photo-detector obtained from the light receiving faces.

5. A focus error signal generating apparatus according to claim 4, wherein
the direction of a dividing line in dividing the light beam into at least two light beams is made to be substantially parallel to the direction of the boundary between at least two light receiving faces which receive the one divided light beam.

6. An optical head comprising:
a light source which emits a light beam;
a condenser lens which condenses the light beam;
a light beam modulating element which divides the light beam condensed by the condenser lens into at least two light beams, applies coma aberration of a predetermined direction to one of the divided light beams; and applies coma aberration of a direction different from the predetermined direction of the coma aberration, to the other divided light beam; and
a photo-detector which detects quantities of light of the two divided light beams as signals,
thereby detecting the signals used for generating a focus error signal of the light beam from the photo-detector.

7. An optical head according to claim 6, wherein
the direction of a dividing line in dividing the light beam into at least two light beams is made to be substantially orthogonal to the directions in which the coma aberrations are added.

8. An optical head according to claim 7, wherein
the photo-detector comprises at least two light receiving faces which receive the one divided light beam and at least two light receiving faces which receive the other divided light beam,
thereby detecting the signals used for generating a focus error signal, from the light receiving faces.

9. An optical head according to claim 8, wherein
the direction of a dividing line in dividing the light beam into at least two light beams is made to be substantially parallel to the direction of the boundary between at least two light receiving faces which receive the one divided light beam.

10. An optical driving apparatus comprising:
an optical head including a light source which emits a light beam, a condenser lens which condenses the light beam, a light beam modulating element which divides the light beam condensed by the condenser lens into at least two light beams, applies coma aberration of a predetermined direction to one of the divided light beams; and applies coma aberration of a direction different from the predetermined direction of the coma aberration, to the other divided light beam, and a photo-detector which detects quantities of light of the two divided light beams as signals and outputs the detected signals; and
a signal generating circuit which generates a focus error signal of the light beam from the signals outputted from the photo-detector.
